(19) United States
(12) Patent Application Publication
(10) Pub. No.: US 2008/0268867 A1
(43) Pub. Date: Oct. 30, 2008

(54) Notification Apparatus and Method for Cellular Communication System

(75) Inventor: Alejandro Cadenas, Madrid (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/914,456

(22) PCT Filed: May 26, 2006
(86) PCT No.: PCT/US06/20593

§ 371 Date: Jun. 19, 2008

(30) Foreign Application Priority Data
Jun. 9, 2005 (GB) 0511795.7

(51) Int. Cl. H04Q 7/20

(52) U.S. Cl. 455/456.1

(57) ABSTRACT

A notification apparatus for a cellular communication system may transmit a notification message to nearby remote terminals if a first remote terminal (101) cannot be contacted. The notification apparatus comprises a call setup detector (203) detecting an unsuccessful incoming call setup for the first remote terminal (101). The call setup detector (203) is coupled to a first location processor (209) determining a location of the first remote terminal (101). A second location processor (211) determines a location of at least a second remote terminal (103) and a distance processor (213) evaluates a distance criterion for the first remote terminal (101) and the second remote terminal (103). A notification processor (215) transmits a notification message to the second remote terminal in response to the distance criterion. The notification message comprises information that the incoming call setup for the first remote terminal is attempted.

### FIELD OF THE INVENTION

The invention relates to a notification apparatus and method for a cellular communication system and in particular, but not exclusively, to notification of failed call attempts in a 3^{rd} Generation Cellular Communication system.

### BACKGROUND OF THE INVENTION

In the last decade, cellular communication systems have become ubiquitous and in many countries the uptake of cellular communication devices approach or even exceed 100% of the population.

As cellular communication systems mature, there is an ever increasing trend to provide new services, facilities and options which provide differentiation and the possibility of additional revenue. For example, customisable ring tones for mobile phones have become a large source of additional revenue for many service providers as well as for independent businesses. As another example, cellular communication services and applications for route navigation have been proposed and introduced in recent years.

One of the most common sources of frustration for users of cellular communication systems is that it is not always possible to establish connection with a remote terminal.

Such a failure may be due to a number of different causes including for example:
The called remote terminal is out of coverage of the base stations and thus no communication link can be established over the air interface.
The user of the called remote terminal cannot hear the alert signal from the remote terminal. For example, it is typical to carry a mobile phone in a bag and when the user is in a noisy environment and the sound of the ring tone may frequently be overshadowed by other noise.
The incoming call is ignored by the user of the called remote terminal.
The functionality of the received called remote terminal may prevent the connection being made. For example, if the remote terminal can only support one call at a time and it is already involved in an active call, the incoming call will be ignored.

Hence, it would be advantageous if an enhanced user experience and facilitated user operation can be achieved. In particular improved notification of incoming calls and/or facilitated or improved accessibility of users of a cellular communication system would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided notification apparatus for a cellular communication system, the apparatus comprising: means for detecting an unsuccessful incoming call setup for a first remote terminal; means for determining a location of the first remote terminal; means for determining a location of at least a second remote terminal; means for evaluating a distance criterion for the first remote terminal and the second remote terminal; means for transmitting a notification message to the second remote terminal in response to the distance criterion, the notification message comprising information that the incoming call setup for the first remote terminal is attempted.

The invention may allow an improved user experience in a cellular communication system. In particular, user accessibility may be improved. An additional service for notifying a user of an intention to contact him may be provided. A practical and convenient notification may be provided by sending notification messages to other suitable remote terminals. Furthermore, the invention may provide a value-added service and may provide an important source of revenue for the operators of the cellular communication system.

The distance criterion may be a criterion that a physical distance between the first remote terminal and the second remote terminal meets a given predetermined criterion. The predetermined criterion may specifically be a criterion that indicates that the first and second remote terminals are close to each other.

The invention may allow one user to be alerted that a call setup is directed to another user if the first user is sufficiently close and a call is not successfully set up.

The notification of the second remote terminal may be performed without the instigator of the call setup knowing that it is being done and/or without knowing the identity of the second remote terminal. This feature may e.g. be configurable by an operator and may e.g. depend on whether the service is being provided to a company. Likewise, the notification of the second remote terminal may be performed without the user of the first remote terminal knowing that it is being done and/or without knowing the identity of the second remote terminal. Furthermore, the notification message need not comprise information relating to the instigator of the call. Again, it may be configurable whether such information is included. Thus, the notification of other users may be achieved while retaining a high degree of privacy.

The remote terminal may be e.g. a 3rd Generation cellular communication system User Equipment (UE), a Global System for Mobile communication (GSM) remote terminal, a subscriber unit, a remote terminal, a communication terminal, a personal digital assistant, a laptop computer, an embedded communication processor or any physical, functional or logical communication element which is capable of communicating with a base station over the air interface of a cellular communication system.

According to an optional feature of the invention, the apparatus further comprises means for determining a group of remote terminals to which the first remote terminal belongs and means for selecting the second remote terminal as another remote terminal belonging to the group. A priority algorithm may be implemented depending on the configuration of the procedure.

This may provide improved functionality and suitability for many applications and environments. For example, it may ensure that only remote terminals and thus users having a special relationship with the first remote terminal and/or the user thereof may be notified.

According to an optional feature of the invention, the group is a community group of users.

The community group may for example be a group of user identities which may have a special social relationship such as a buddy group, a group of friends, a group of colleagues, a family group, a group for a specific company, etc. The community group may e.g. be manually set up by the user of the first remote terminal, of the second remote terminal or another user associated with the group.

According to an optional feature of the invention, the apparatus further comprises means for ranking remote terminals of the group and means for sequentially selecting a next ranked remote terminal as the second remote terminal.

This may allow an improved user experience and/or customisation of individual preferences and/or current conditions. It may allow a faster and simpler determination of a remote terminal suitable for receiving a notification message for a call set up for the first remote terminal.

According to an optional feature of the invention, the selection means is arranged to continue sequentially selecting the next ranked remote terminal until a predetermined number of notification messages have been sent to the second remote terminal.

The feature may allow an efficient means of sending notification messages to a desired number of remote terminals.

According to an optional feature of the invention, the ranking comprises a predetermined prioritised sub-grouping of the remote terminals of the group.

This may allow for an efficient way of controlling who the notification message is sent to. An improved customisation and targeting of the notification message may be achieved with low complexity. Different subgroups may for example be formed corresponding to work colleagues, friends, family members etc.

According to an optional feature of the invention, the ranking is time dependent. For example, the ranking may depend on the time of the call attempt. This may provide improved customisation and targeting of the notification message to the current conditions.

According to an optional feature of the invention, the selection means is arranged to sequentially select all remote terminals of the group as the second remote terminal.

This may ensure that all suitable candidates for receiving a notification message are considered. In particular, all remote terminals belonging to the group and for which the distance criterion is met may be notified.

According to an optional feature of the invention, the transmitting means is arranged to transmit the notification message if the distance between the first remote terminal and the second remote terminal is less than distances between the first remote terminal and other remote terminals of the group.

The distance criterion may specifically require that the distance between the first remote terminal and second remote terminal is the smallest of the group. If the determined distance is the same for different remote terminals, the notification message may e.g. be transmitted to only one of these or to all of these. In some scenarios a suitable accuracy of the distance determination may be in the order of meters.

According to an optional feature of the invention, the transmitting means is arranged to transmit the notification message if the distance between the first remote terminal and the second remote terminal is less than a predetermined threshold.

This may provide an efficient notification wherein close remote terminals are notified of a call for another remote terminal.

According to an optional feature of the invention, the apparatus further comprises: means for, if the distance criterion is not met, selecting a third remote terminal, determining a location of the third remote terminal; evaluating the distance criterion for the first remote terminal and the third remote terminal, and transmitting the notification message to the third remote terminal in response to the distance criterion.

This may allow an efficient identification of a suitable remote terminal for receiving the notification message.

According to an optional feature of the invention, the apparatus further comprises: means for detecting that the notification message is not successfully received by the second remote terminal; and means for, if the notification message is not successfully received by the second remote terminal, selecting a third remote terminal, determining a location of the third remote terminal; evaluating the distance criterion for the first remote terminal and the third remote terminal, and transmitting the notification message to the third remote terminal in response to the distance criterion.

This may allow an efficient identification of a suitable remote terminal for receiving the notification message.

The means for detecting that the notification message is not successfully received may for example detect that a connection could not be established to the second remote terminal or that no acknowledgement of the notification message is received.

According to an optional feature of the invention, the distance criterion comprises a criterion that the distance between the first remote terminal and the second remote terminal is less than 10 meters.

This may allow the notification message to be transmitted only to remote terminals for which the user may practically and easily inform the user of the first remote terminal of the notification message.

According to an optional feature of the invention, the location of the first remote terminal or the second remote terminal is determined as a serving cell location.

This may allow a low complexity implementation and in particular may allow a low complexity location determination which may particularly obviate or mitigate the need for a dedicated location determination. The feature may be particularly advantageous in systems with very small cells such as for example a pico-cell environment.

According to an optional feature of the invention, the notification message is a text message. This may provide for a suitable and low complexity notification. The text message may for example be a Short Message Service (SMS) text message.

According to an optional feature of the invention, the apparatus further comprises means for determining a notification service requirement status for the first remote terminal and the apparatus is arranged to only transmit the notification message if the notification service requirement status indicates that a user of the first remote terminal desires the notification message to be transmitted.

This may e.g. allow a user to customise the notification operation. For example, the user of the first remote terminal may select between a mode of operation wherein notifications may be sent to other remote terminals and a mode of operation wherein notifications may not be sent.

According to an optional feature of the invention, the apparatus further comprises means for receiving a notification service request from the call instigator and the apparatus is arranged to only transmit the notification message if the notification service request has been received.

This may allow the instigator of the call setup to control the operation of the notification apparatus. In particular, it may control whether notification messages are transmitted if the call cannot be set up.

The notification service request may for example be received with the call and possibly be indicated by a specific characteristic associated with the call setup and/or may be a request received separately.

According to an optional feature of the invention, the location of the first remote terminal is determined as a past location of the first remote terminal.

This may allow a low complexity implementation and/or may allow improved operation. For example, if the current location of the first remote terminal cannot be determined (e.g. because the first remote terminal is switched off), notification messages may be transmitted to another remote terminal close to the first remote terminal's last known location.

According to a second aspect of the invention, there is provided a notification method for a cellular communication system, the method comprising: detecting an unsuccessful incoming call setup for a first remote terminal; determining a location of at least a second remote terminal; evaluating a distance criterion for the first remote terminal and the second remote terminal; and transmitting a notification message to the second remote terminal in response to the distance criterion, the notification message comprising information that the incoming call setup for the first remote terminal is attempted.

According to a third aspect of the invention, there is provided computer program product for executing the method described above.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of this invention; and

FIG. 2 illustrates an example of a notification server in accordance with some embodiments of this invention.

### DETAILED DESCRIPTION OF SOME EMBODIMENTS OF THE INVENTION

The following description focuses on embodiments of the invention applicable to a UMTS (Universal Mobile Telecommunication System) cellular communication system but it will be appreciated that the invention is not limited to this application and may be applied to many other communication systems including for example a GSM (Global System for Mobile communication system) cellular communication system.

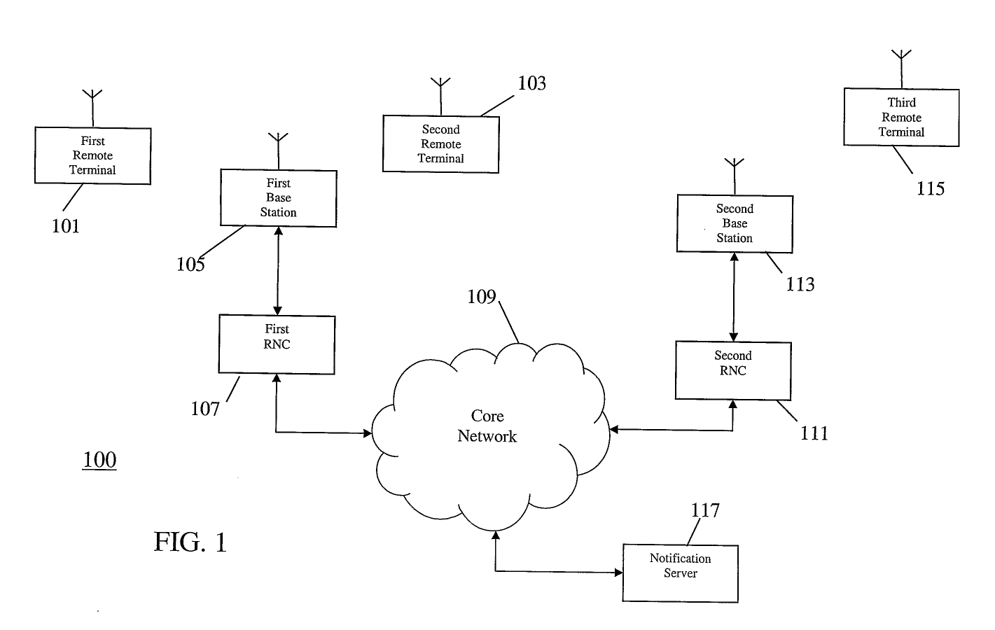

FIG. 1 illustrates an example of a cellular communication system 100 in which embodiments of the invention may be employed.

In a cellular communication system, a geographical region is divided into a number of cells each of which is served by a base station. The base stations are interconnected by a fixed network which can communicate data between the base stations. A remote terminal (e.g. a User Equipment (UE) or a mobile station) is served via a radio communication link by the base station of the cell within which the remote terminal is situated.

As a remote terminal moves, it may move from the coverage of one base station to the coverage of another, i.e. from one cell to another. As the remote terminal moves towards a base station, it enters a region of overlapping coverage of two base stations and within this overlap region it changes to be supported by the new base station. As the remote terminal moves further into the new cell, it continues to be supported by the new base station. This is known as a handover or handoff of a remote terminal between cells.

A typical cellular communication system extends coverage over typically an entire country and comprises hundreds or even thousands of cells supporting thousands or even millions of remote terminals. Communication from a remote terminal to a base station is known as uplink, and communication from a base station to a remote terminal is known as downlink.

In the example of FIG. 1, a first remote terminal 101 and a second remote terminal 103 are in a first cell supported by a first base station 105.

The first base station 105 is coupled to a first RNC 107. An RNC performs many of the control functions related to the air interface including radio resource management and routing of data to and from appropriate base stations.

The first RNC 107 is coupled to a core network 109. A core network interconnects RNCs and is operable to route data between any two RNCs, thereby enabling a remote terminal in a cell to communicate with a remote terminal in any other cell. In addition, a core network comprises gateway functions for interconnecting to external networks such as the Public Switched Telephone Network (PSTN), thereby allowing remote terminals to communicate with landline telephones and other communication terminals connected by a landline. Furthermore, the core network comprises much of the functionality required for managing a conventional cellular communication network including functionality for routing data, admission control, resource allocation, subscriber billing, remote terminal authentication etc.

The core network 109 is further coupled to a second RNC 111 which is coupled to a second base station 113. The second base station 113 supports a third remote terminal 115.

In the specific example of FIG. 1, the third remote terminal 115 attempts to set up a call to the first remote terminal 101 and if the call setup is unsuccessful, a notification message is automatically and possibly without the knowledge of the third remote terminal 115 generated and set to the second remote terminal 103.

Specifically, the cellular communication system 100 comprises a notification server 117 which detects an unsuccessful call attempt and in response determines another remote terminal close to the first remote terminal 101. The notification server 117 then generates a notification message and transmits this to the identified remote terminal.

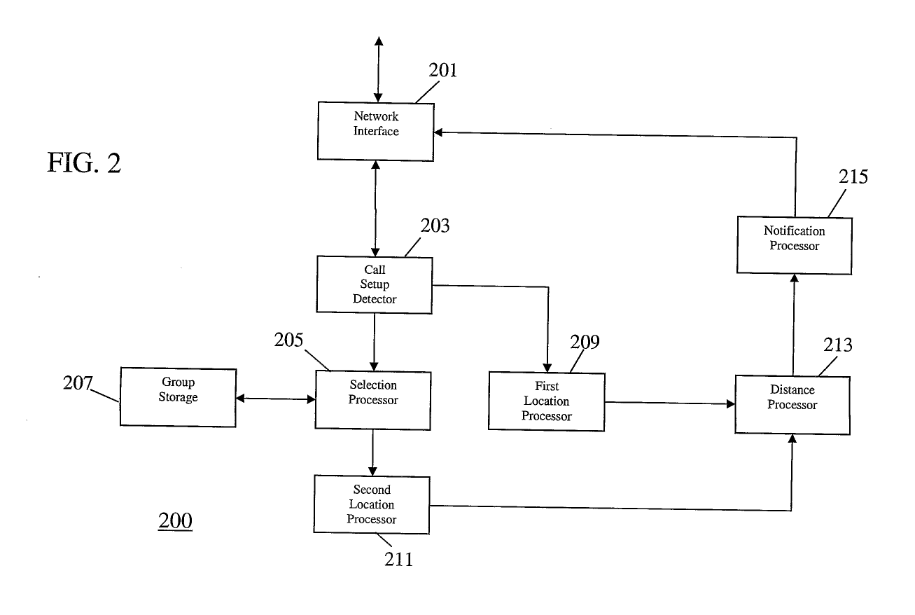

FIG. 2 illustrates an exemplary block diagram of the notification server 117 of FIG. 1.

The notification server 117 comprises a network interface 201 which interfaces to the core network 109 and is operable to communicate with other network elements of the core network.

The network interface 201 is coupled to a call setup detector 203 which is arranged to detect an unsuccessful incoming call setup for a first remote terminal 101. For example, whenever a call attempt is attempted but is not successful, the core network 109 may generate a message for the notification server 117 which identifies the calling party as well as the remote terminal being called. The call detector 203 may then evaluate this message to determine if the call setup attempt is for the first remote terminal 101.

It will be appreciated that there are many ways of implementing a suitable unsuccessful call detection and that the interface, interoperation and distribution of functionality between different network elements may be varied in different embodiments. For example, in some embodiments, the core network may filter the call setups and may only send messages to the notification server 117 for call setups meeting specific criteria such as for example only for call setups in certain cells, certain types of calls and/or for certain remote terminals.

In some cases, the notification server 117 may be located such that it may intercept standard call setup messages and may evaluate these to see if they relate to the first remote terminal 101. It may then continue to evaluate the call setup messages to determine if the call is successful.

An unsuccessful call attempt may fail for a number of reasons, including for example due to the recipient user ignoring the call or the remote terminal being out of coverage. In some embodiments, the call setup detector 203 may be arranged to detect only some types of call setup failure and notifications may only be generated for these types of setup failures.

It will also be appreciated that the call setup may relate to any suitable call such as a standard telephony voice call, a packet data call, a circuit switched call etc. In some embodiments, a notification message may only be sent to other remote units for certain types of calls, e.g. only for voice calls and not for data calls.

The call setup detector is coupled to a selection processor 205 which is arranged to select a remote terminal as a possible candidate for receiving a notification message relating to the failed call setup attempt.

In the example of FIG. 2, the selection processor 205 is coupled to a group storage 207 which comprises stored information for a group of remote terminals which may be candidates for receiving the notification message. In the specific example, the selection processor 205 selects the second remote terminal 103.

The call setup detector 203 is also coupled to a first location processor 209 which determines a location of the first remote terminal 101.

It will be appreciated that any suitable way of determining the location may be used. For example in some, embodiments the first remote terminal 101 may comprise a Global Positioning System (GPS) receiver which determines the location locally in the first remote terminal 101. The location may then at regular intervals be uploaded to the network and may be forwarded to the notification server 117.

In other embodiments, a network centric location determination may be used. For example, as well known to the person skilled in the art, a number of techniques are known for determining a location of a remote terminal based on arrival times at a plurality of base stations of signals from the remote terminal. Such location estimates may be determined at regular intervals and fed to the notification server 117. Specifically, this does not require any specific extra capability from the handset perspective

As a specific example, when the first location processor 209 receives an identification of the first remote terminal 101 from the call setup detector 203, it may contact a location server of the core network 109 and request the current (or last known) location of the first remote terminal 101.

In some embodiments, the location may simply be determined as the location of the cell. Thus, the location determination may have a granularity corresponding to the cell size. This may allow a simple location determination as the network need not determine any specific location information but can simply use the existing information of which base station is currently the serving base station. Such an approach may be particularly suitable in scenarios with small cell sizes, such as for example in pico-cell environments.

The selection processor 205 is coupled to a second location processor 211 which is arranged to determine a location of the second remote terminal 103. The location of the second remote terminal 103 may be determined in a similar way to the determination of the location of the first remote terminal 101.

It will be appreciated that in some situations, it may not be feasible or practical to determine the current location of the first remote terminal 101 or the second remote terminal 103. For example, if the first remote terminal 101 is switched off, the network may not be able to determine the location of the terminal. In some embodiments, the last known location of a remote terminal may be used if the current location cannot be determined. For example, if the first remote terminal 101 is switched off, the last determined location before it was switched off may be stored and used by the notification server 117.

The first location processor 209 and the second location processor 211 are coupled to a distance processor 213 which is arranged to evaluate a distance criterion for the first remote terminal 101 and the second remote terminal 103.

Specifically, the distance processor 213 may evaluate a physical distance between the first remote terminal 101 and the second remote terminal 103.

In many embodiments, the distance criteria may simply correspond to a determination of whether the first remote terminal 101 and the second remote terminal 103 are sufficiently close to each other. As a low complexity example, the distance processor 213 may evaluate if the distance between the first remote terminal 101 and the second remote terminal 103 is less than a predetermined threshold. For example, the distance processor 213 may determine if the distance between the first remote terminal 101 and the second remote terminal 103 is less than 10 meters. If so, the distance criterion is met and it is likely that the first remote terminal 101 and the second remote terminal 103 are very close to each other.

The distance processor 213 is coupled to a notification processor 215 which is further coupled to the network interface 201. The distance processor 213 is arranged to transmit a notification message to the second remote terminal 103 if the distance processor 213 determines that the distance criterion is met.

The notification message may be any suitable message comprising information that the incoming call setup for the first remote terminal is attempted. In some embodiments, the message may be a text message which is sent to the second remote terminal 103. The text message may for example be a Short Message Service (SMS) text message or may be a text message sent using a service having a guaranteed minimum delivery time.

The notification message may for example comprise information that the first remote terminal 101 is being called by the third remote terminal 115. In many embodiments, a user identity associated with the remote terminals may be used rather than the remote terminal identities themselves. Specifically, the notification server 117 may comprise information associating the remote terminals with user identities which may then be used in the message.

For example, if the notification server 117 has information that the first remote terminal 101 is associated with a user identity of “Bob” and the third remote terminal is associated with a user identity of “Alice”, the following notification text message may for example be generated:

“Please tell Bob that Alice is currently trying to contact him”

Thus, the notification server 117 may allow an improved accessibility in a cellular communication systems as users may in some cases be reached through intermediaries even if they are not themselves contactable. Furthermore, suitable intermediaries may be automatically identified. For example, by evaluating a number of possible candidates, the notification server 117 may automatically identify users near to the called used while not inconveniencing any users unlikely to be able to assist in contacting the called user.

The functionality may be implemented by low complexity means and a new user service may be provided enhancing the user experience and mitigating one of the most common sources of frustration for users of a cellular communication system.

Furthermore, the notification server 117 may be implemented as a single add-on solution to existing networks. Thus, a flexible and easy deployment may be achieved.

In the embodiment of FIG. 2, the group storage 207 comprises information for a plurality of remote terminals belonging to users of a specific community group. For example, for a given user/remote terminal, the group storage 207 comprises information of a group of users and corresponding remote terminals which have a given relationship to the first user.

As a specific example, for the first remote terminal 101, the group storage 207 may comprise a list of remote terminals belonging to friends of the user of the first remote terminal 101, another list of remote terminals belonging to family members and a third list of remote terminals belonging to colleagues of the user. The group storage 207 may comprise additional information for the first remote terminal 101 and/or the associated remote terminals.

In the example of FIG. 2, the selection processor 205 accesses the group storage 207 with the identity of the first remote terminal 101 and receives a list of the remote terminals belonging to the community group of the first remote terminal 101.

The selection processor 205 may then proceed to select one of these remote terminals and forward it to the second location processor 211 for location determination. The distance criterion may be evaluated for the selected remote terminal and if the criterion is met, the notification processor 215 may be instructed to generate a notification message of this remote terminal.

The selection processor 205 may then proceed to select another remote terminal from the group and may process this in the same way. In this way, the notification server 117 may sequentially go through the remote terminals associated with the remote terminal being called and may generate notification messages for the remote terminals which meet the distance criterion. In particular for specific example, the notification server 117 may generate notification messages for all remote terminals which are in the same community group as the first remote terminal 101.

In some embodiments, the notification server 117 may consider all remote terminals of the community group and may send a notification message to all suitable remote terminals. In other embodiments, the notification server 117 may sequentially consider remote terminals until a predetermined number of notification messages have been sent and may then terminate the process.

For example, the notification server 117 may sequentially consider the remote terminals of the community group until one notification message has been sent and may then terminate the process.

In some embodiments, the notification server 117 may determine if the notification message has been successfully received by the appropriate remote terminal. For example, in some embodiments, the remote terminal may send an acknowledgement to the notification server 117 in response to receiving the notification message. The notification server 117 may then detect if a transmitted notification message has not been successfully received and may proceed to consider another remote terminal from the community group until the notification message has been successfully received by a remote terminal in the group.

In some embodiments, the notification server 117 may further detect if no suitable remote terminals of the community group have been received and may then transmit a notification to the third remote terminal 115 indicating that the call setup has been unsuccessful and that no notification message has been sent to any other remote terminals.

In some embodiments, the distance criterion may be that the distance between the remote terminal and the first remote terminal 101 is the lowest (possibly including being identical to another distance) for all remote terminals of the group. Thus, the notification server 117 may identify the closest remote terminal from the group and may transmit a notification message to this remote terminal. The notification server 117 may for example sequentially go through all remote terminals of the group and may store the identity and distance for the remote terminal so far having the lowest distance. If another remote terminal is found having a lower distance, this distance and the remote terminal identity is stored. When all remote terminals of the group have been considered, the notification server 117 may proceed to transmit a notification message to the stored remote terminal identity.

In some embodiments, the notification server 117 may rank the remote terminals of the community group and may consider these in the ranked order.

For example, the remote terminals in the community group may be ordered manually by the user of the first remote terminal 101 and the notification server 117 may go through the list in the order selected by the user. If only a predetermined number of notification messages are to be sent, these will accordingly be transmitted to the preferred remote terminals which meet the distance criterion.

As an example of a simple ranking, the remote terminals of the community group may be divided into different subgroups and the individual subgroups may be prioritised with respect to each other. For example, the community group may comprise a first subgroup corresponding to family members, a second subgroup corresponding to friends, a third subgroup corresponding to colleagues and a fourth subgroup corresponding to users which do not belong to any of the previous groups. It will be appreciated that in such an example, a remote terminal/user may belong to more than one subgroup.

In the example, the notification server 117 may prioritise the subgroups such that the friends subgroup is first evaluated. If a remote terminal meeting the distance criterion is identified, a notification message may be sent to this and if only one notification message is required to be sent, the process may terminate. However, if no remote terminal is identified, the notification server 117 may proceed to evaluate the family subgroup followed by the colleague subgroup and finally the subgroup containing the remaining members of the community group. In this way a simple to implement and manage notification service may be established which may transmit notification messages to suitable remote terminals.

In some embodiments, the prioritisation or ranking may be time dependent. For example, the colleague subgroup may be the highest ranked during working hours, the friends group may be the highest ranked group in the evenings and the family group may be the highest ranked group at daytime during weekends. This may allow a customised targeting of the notification message.

It will be appreciated that the group information may be generated and stored in any suitable way. For example, the information may be generated by monitoring of the user's behaviour such as for example monitoring the remote terminals calling or called by the first remote terminal 101 at different times. Alternatively or additionally, the information may be manually entered for example by the user of the first remote terminal 101 or by a service operator.

In some embodiments, the first remote terminal 101 and/or the third remote terminal may control whether notification messages should be sent or not.

For example, the first remote terminal 101 may control a status indication at the notification server 117 and a notification message may only be sent if the first remote terminal 101 has set this status to indicate that notification messages may be sent to other remote terminals if the first remote terminal 101 cannot be reached.

Similarly, the third remote terminal may specifically request that notification messages are sent by sending a notification service request to the notification server 117. Such a notification service request may for example be a dedicated and explicit message requesting the service or may be a characteristic of the call setup itself. For example, the first remote terminal 101 may be associated with two different phone numbers and if the first number is called, a notification message may be generated and if the second number is called no notification message will be generated.

Thus, the users of the first remote terminal 101 and the third remote terminal 115 may thus in some embodiments control whether notification messages are to be sent. In some embodiments, the other remote terminals of the community group may also control whether they are available for receiving notification messages. Thus, a very flexible notification system may be implemented wherein the individual users may control the way in which they participate in the notification process.

It will be appreciated that the described systems may allow notifications to be generated while ensuring that sensitive information is not distributed. For example, the remote terminals may be evaluated and the notification messages transmitted without any information being provided to the third remote terminal 115 of where these notification messages are transmitted or even that they are transmitted. Thus, the user of the third remote terminal 115 need not be provided with any information of which remote terminals are included in the first remote terminal's 101 community group. Accordingly, an improved accessibility may be achieved without sacrificing the privacy of the first remote terminal 101 or any remote terminals in the community group.

In some embodiments, the second remote terminal 103 may generate an acknowledgement that the notification message has been received and/or that the user of the first remote terminal 101 has been contacted by the user of the second remote terminal 103. Such an acknowledgement may e.g. be sent in response to a manual action performed by the user of the second remote terminal 103 (e.g. he may simply press a suitable button the terminal) and may be sent back to the third remote terminal 115. In this way the user of the third remote terminal 115 may be made aware that the notification has been successful.

It will be appreciated that the described notification system may be useful in many scenarios and can be used to provide an enhanced service of the cellular communication system.

In the following a very specific example is given of how such a system may be used.
Bob is a young adult. Alice is Bob's mother. It's very late Saturday and Bob should have arrived home some time ago. Alice is getting nervous.
Alice tries to call Bob, but Bob cannot hear the mobile or may simply be ignoring it.
Bob is likely to be with some of his friends, so Alice selects the notification feature and calls Bob.
Bob has 4 friends in his community group: Charles, Dick, Edward, and Franck. The notification server 117 evaluates the community group.
The notification server 117 first considers Charles. Charles is not connected, so no further action is taken
The notification server 117 then considers Dick. Dick is connected so his location is determined. The distance between Bob's coordinates and Dick's coordinates is too large. Unfortunately Dick is at home and is not near Bob.
The notification server 117 then considers Edward. The process is repeated but this time the distance between Bob's coordinates and Edward's coordinates is below the required distance.
The notification server 117 sends a notification message to Edward's remote terminal saying “Alice is trying to contact Bob”. Edward sees the message and tells Bob who may then contact his mother. It may be the case that Alice and Edward do not know each other and in order to protect Edward's privacy, Alice just knows that she is sending a notification message to someone close to Bob.

It will be appreciated that there are many other possible scenarios and applications such as e.g.:
Location during family emergencies.
Police and private security companies.
Taxi or transport companies.
Professional technical support services.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. A notification apparatus for a cellular communication system, the apparatus comprising:
means for detecting an unsuccessful incoming call setup for a first remote terminal;
means for determining a location of the first remote terminal;
means for determining a location of at least a second remote terminal;
means for evaluating a distance criterion for the first remote terminal and the second remote terminal;
means for transmitting a notification message to the second remote terminal in response to the distance criterion, the notification message comprising information that the incoming call setup for the first remote terminal is attempted.

2. The apparatus of claim 1 further comprising means for ranking remote terminals of the group and means for sequentially selecting a next ranked remote terminal as the second remote terminal.

3. The apparatus of claim 2 wherein the selection means is arranged to continue sequentially selecting the next ranked remote terminal until a predetermined number of notification messages have been sent to the second remote terminal.

4. The apparatus of claim 2 wherein the ranking is time dependent.

5. The apparatus of claim 2 wherein the transmitting means is arranged to transmit the notification message if the distance between the first remote terminal and the second remote terminal is less than distances between the first remote terminal and other remote terminals of the group.

6. The apparatus of claim 1 wherein the transmitting means is arranged to transmit the notification message if the distance between the first remote terminal and the second remote terminal is less than a predetermined threshold.

7. The apparatus of claim 1 further comprising means for determining a notification service requirement status for the first remote terminal and wherein the apparatus is arranged to only transmit the notification message if the notification service requirement status indicates that a user of the first remote terminal desires the notification message to be transmitted.

8. The apparatus of claim 1 further comprising means for receiving a notification service request from an instigator of the incoming call attempt and wherein the apparatus is arranged to only transmit the notification message if the notification service request has been received.

9. The apparatus of claim 1 wherein the location of the first remote terminal is determined as a past location of the first remote terminal.

10. A notification method for a cellular communication system, the method comprising the steps of:
detecting an unsuccessful incoming call setup for a first remote terminal;
determining a location of the first remote terminal;
determining a location of at least a second remote terminal;
evaluating a distance criterion for the first remote terminal and the second remote terminal; and
transmitting a notification message to the second remote terminal in response to the distance criterion, the notification message comprising information that the incoming call setup for the first remote terminal is attempted.
